(19) United States
(12) Patent Application Publication
(10) Pub. No.: US 2003/0074578 A1
(43) Pub. Date: Apr. 17, 2003

(54) Computer virus containment

(76) Inventors: Richard Ford, Boca Raton, FL (US); David Mendenhall, North Bay Village, FL (US); Christopher Fleck, Boca Raton, FL (US); Chester A. Heath, Boca Raton, FL (US); Bart J. Brooks, Boca Raton, FL (US)

Correspondence Address: KAPLAN & GILMAN , L.L.P., 900NROUTE 9 NORTH, WOODBRIDGE, NJ, 07095, US

(21) Appl. No.: 10/005,886

(22) Filed: Dec. 5, 2001

Related U.S. Application Data
(60) Provisional application No. 60/329,635, filed on Oct. 16, 2001.

(51) Int. Cl. G06F 11/30

(52) U.S. Cl. 713/200

(57) ABSTRACT

This invention provides a system for the prevention of the spread of a computer virus by intercepting outgoing messages from a computer device and determining whether the message is of an acceptable type. The system is provided as a firedoor that compares outgoing messages to a previously established list of approved actions and, if the message does not conform to an approved action on the list, the firedoor blocks transmission and prevents the virus from spreading any further. If a further embodiment, multiple firedoors are applied in a cascaded series to compare the transmission to different acceptance criteria in tandem.

### FIELD OF THE INVENTION

The present invention relates to the field of computer networks, and more particularly to the prevention of broadcasting computer viruses.

### RELATION TO OTHER APPLICATION

This application is a conversion of the provisional patent application serial No. 60/329,635, filed Oct. 16, 2001.

### BACKGROUND OF THE INVENTION:

An unfortunate corollary to the advancement of computer based communications has been the increased quantity and sophistication of debilitating, transferable, unwanted programs commonly known as computer viruses. Viruses are sent to a host computer through an electronic mail transmission and destroy memory and files, causing considerable damage. Most viruses contain imbedded instructions to cause the host to send a duplicate copy of the virus to all the email addresses in the computer's address book, resulting in an epidemic. More recent computer virus developments have been directed to network servers, computers that are connected to a large numbers of client devices, such that if the server is destroyed, the clients are inoperative. Such server viruses are spread by requiring the affected server to send the infected message to further servers or other network devices.

Servers, being essentially special purpose computers, are capable of acting on instructions, of either responding to the sender of an incoming message or of initiating an unresponsive message. An example of the latter is if the server receives an instruction from a first source to send a message to a second destination, such as another computer server or all the client computers on the network. The message sent to the recipient destination is an unresponsive message. If such a message carries a virus, the group of recipients may be damaged thereby. An existing protective program, known as a “Reverse Firewall™” is available from Cs3, Inc. of Los Angeles, Calif. The Reverse Firewall program identifies server-generated transmissions that are not in response to an incoming communication and causes the new transmissions to be broadcast at slow speed, thus reducing the rate of spread and allowing intended recipients to be protected. Another existing virus protective system, provided by Network Ice Corporation and known as BlackICE Guard, is stated to intercept transmissions into and out from a computer and stop virus infected messages.

The present invention provides protection for computer servers through a novel and highly efficient system as described below.

### SUMMARY OF THE INVENTION

The invention disclosed below provides a system by which a barrier for containing a computer virus is established. The system prevents the spread of a virus by a server or other computer device by allowing the device to perform only certain operations. If the device generates and transmits a message, that message is first compared to a pre-established set of acceptable operations. If the message is found to be within the ambit of the pre-established acceptable operations, the message may be sent out. Otherwise, the message is effectively aborted, protecting against the spread of the virus.

### BRIEF DESCRIPTION OF THE DRAWINGS

FIG. 1 is a schematic diagram of the propagation of a virus from a first infected server to a plurality of additional servers.

FIG. 2 is a schematic layout of a server being protected from infected incoming data and prevented from transmitting unapproved outgoing data according to the present invention.

FIG. 3 is a schematic diagram of a plurality of connected servers, including the dual protected server of FIG. 2.

FIG. 4 is a block diagram depicting a second embodiment of the present invention.

FIG. 5 shows a flowchart of the method employed by the invention outgoing protective device of the present invention.

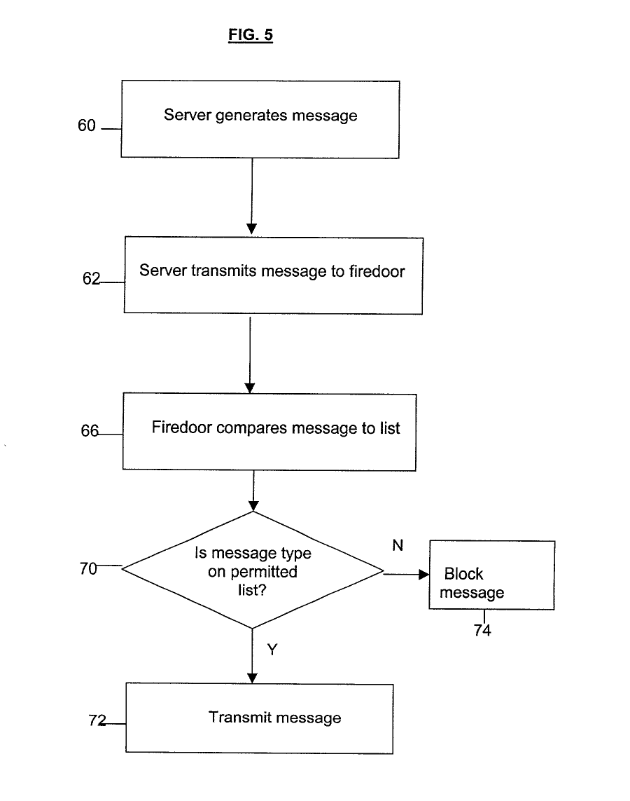

### DETAILED DESCRIPTION OF THE INVENTION

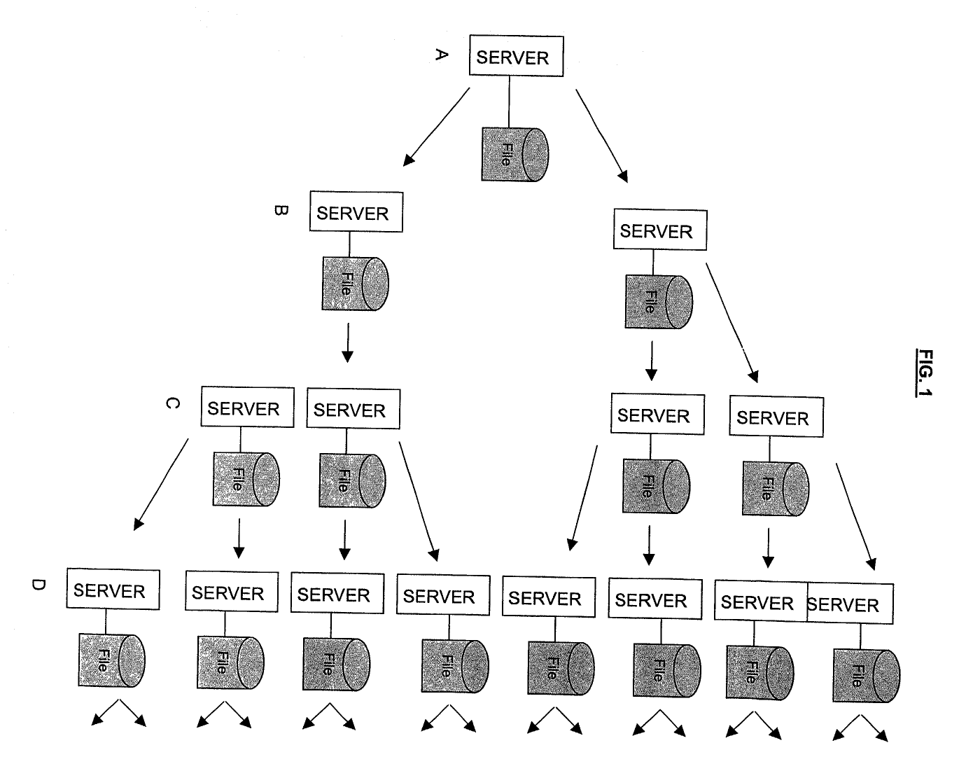

FIG. 1 shows a diagrammatic representation of the propagation of a computer virus among servers. The servers are identified as group A, group B, group C and group D in broadening tiers of transmission. When a server in group A (in which only a single server is shown) is infected by receiving a communication containing a virus, the normal activity of this server is subjugated to the instructions in the virus. The virus instructions invariably cause the infected server to replicate and send copies of the virus to additional servers to which it is connected, either by wire or wireless link. In the example of FIG. 1, the server in group A is connected to two servers in group B, and the servers in group B are each connected to two servers in group C; this one-to-two relation is portrayed for clarity and simplicity and is not intended to be construed as a limitation. Even with each server illustrated as being connected to two other servers, the rate of propagation of the virus is rapid.

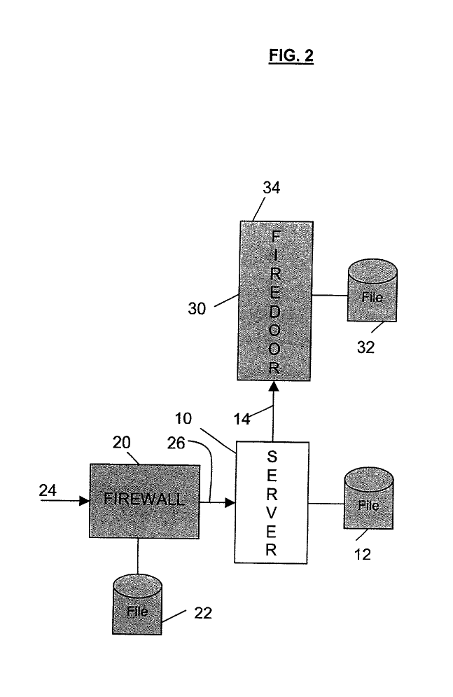

Referring now to FIG. 2, a typical server 10 is protected from unwanted incoming materials 24 which are intercepted by firewall 20. If the incoming material is identified as being undesirable or dangerous when the transmitted material is compared against data stored in associated file 22, firewall 20 serves as a barrier against the material reaching server 10. However, as will be understood by those skilled in the art, each new generation of computer virus becomes better disguised than the last and more difficult to detect. Thus, in those circumstances when the virus is not stopped by firewall 20, it is conveyed to server 10 via transmission link 26. Server 10 will, in accordance with the instructions typically contained in the virus, replicate multiple copies of the virus-laden message and send them out to attempt to infect additional servers or other devices. According to the present invention, server 10 is connected such that all outgoing material from server 10 goes first to firedoor 30. Firedoor 30 is a monitoring device connected so as to intercept, analyze and control outgoing transmissions from server 10, regardless of the route of transmission, input/output port, channel or bus. Firedoor 30 contains a list of permitted actions that is stored, for example, in connected file 32. An example of a permitted action would be the transmission of a response to an externally initiated query or request to establish communication. Additional examples of the type of permitted actions would be transmission to certain addresses or under certain protocols. If the action being attempted is not on the list of permitted actions, firedoor 30 blocks the transmission and effectively aborts the message from being sent along transmission link 34. If firedoor 30 determines that the action is permitted, the message is transmitted.

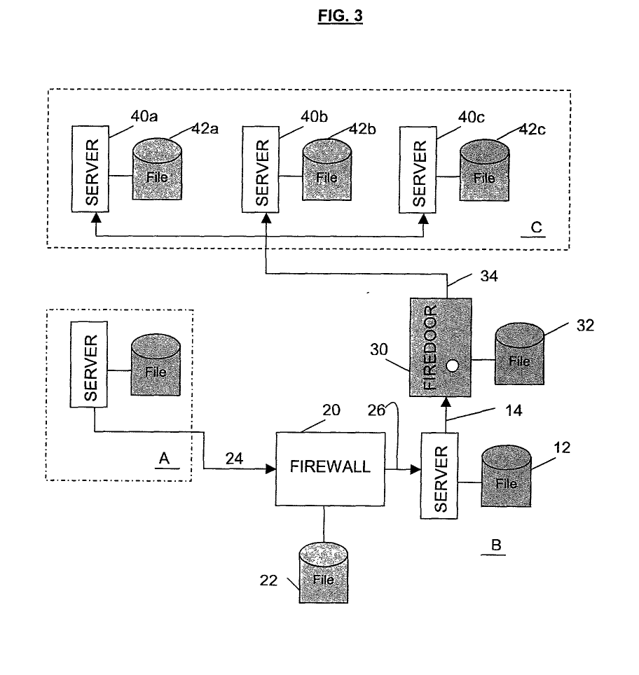

The benefits of the invention are portrayed in the context of a partial network in FIG. 3. The server in group A, pursuant to being infected, sends a copy of the virus to server 10 via transmission link 24. Firewall 20 intercepts the virus-carrying message. If firewall 20 does not recognize the message as being infected, the message is transmitted via transmission link 26 to server 10, representative of servers in group B (per FIG. 1). When server 10 and firedoor 30 operate as described above, only approved material is transmitted via transmission link 34 to servers in group C. When material coming to firedoor 30 is not in conformity to that on the approved actions list stored in file 32, transmission link 34 is blocked and the message aborted. In this manner, the downstream servers and other devices connected to server 10 are protected from the virus. Without continued transmission, a virus becomes ineffective and dies. The invention further recognizes that firedoor 30 can be comprised of two or more firedoor units in cascaded series, each applying a different set of restrictions, e.g. one firedoor only allowing transmission to a known address and the other requiring encryption. In this way, the security of protection is increased significantly by requiring that both conditions are met before the server acts on the stimulus. Additional firedoors can be added to exponentially raise the level of security. An additional measure of security can be attained by establishing an instruction for firedoor 30 to read the server memory to verify critical sequences of code or constants that are typically corrupted in the intrusion process. A firedoor such as that provided is also capable of being programmed to either shut down the server or notify a service center of the existence of a virus.

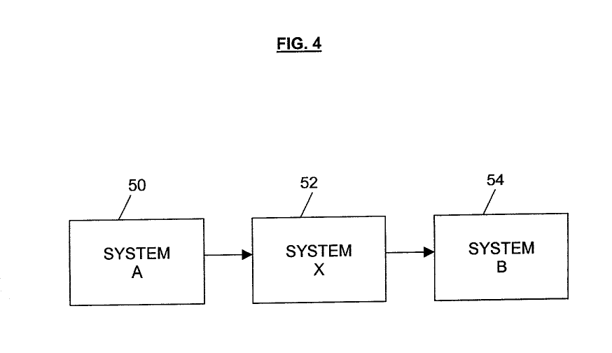

A simplified embodiment of the present invention is shown in FIG. 4 in relation to a pair of generalized system A 50 and system B 54. A system X 52 is installed so as to intercept all transmissions between system A 50 and system B 54. In relation to the description above, system A 50 is representative of a server or other device that has received a virus infected message. System A 50 replicates and transmits copies of the virus to system B 52 which operates as a firedoor to any outgoing material from system A 50. If system X 52 determines that the outgoing material is acceptable, the material is transmitted to system B 54. Otherwise, the material does not get transmitted from system X 52, and the virus is halted.

Referring now to FIG. 4, a flowchart of the operational steps followed by the present invention is illustrated. A server generates a message at step 60 and transmits the message outward in step 62 to a firedoor in accordance with the invention. The firedoor compares the message to a pre-established list of permitted actions in step 66. The system then determines at step 70 whether the message is of the type that conforms to the list of permitted actions. If the message does not conform to the permitted list, the message is blocked from further transmission at step 74. If the message conforms to the approved list, the message is transmitted to its intended recipient at step 72.

While the present invention is described with respect to specific embodiments thereof, it is recognized that various modifications and variations may be made without departing from the scope and spirit of the invention, which is more clearly and precisely defined by reference to the claims appended hereto.

What is claimed is:

1. A method for the containment of a virus in a computer network, comprising evaluating an outgoing message from a computer device and blocking the transmission of the message if it does not conform to an established list of permitted actions.

2. A method for the containment of a virus in a computer network, comprising:
(a) establishing a list of permitted operations in a computer network;
(b) intercepting a message emanating from a device in the computer network;
(c) comparing the intercepted message to the list of permitted operations;
(d) transmitting the message if the message conforms to one of the permitted operations on the list; and
(e) blocking the message if the message does not conform to one of the permitted operations on the list.

3. The method for the containment of a virus in a computer network as described in claim 2, wherein the list of permitted operations comprises permitting transmission only to another network or computer device having one of certain addresses or protocols.

4. The method for the containment of a virus in a computer network as described in claim 2, wherein the list of permitted operations comprises transmission to another network or computer device only in response to an external initiation.

5. The method for the containment of a virus in a computer network as described in claim 2, wherein one of the permitted operations comprises establishing communications between two servers or the like devices.

6. The method for the containment of a virus in a computer network as described in claim 2, further comprising transmitting the message only if the message conforms to a first and a second of the permitted operations on the list.

7. A firedoor system for the containment of a virus in a computer network, comprising a firedoor for receiving a message from a computer device, comparing the received message to an established list of permitted operations and transmitting the received message only if it conforms to the list of permitted operations.

8. A firedoor system for the containment of a virus in a computer network, comprising:
(a) a firewall connected to the computer network so as to receive messages from an outside source and adapted for screening unwanted messages;
(b) a computer device connected to receive messages passed by the firewall; and
(c) a firedoor connected to the computer device so as to receive messages from the computer device and to evaluate the received messages and transmit only permitted messages to other computer devices in the computer network.

9. The firedoor system for the containment of a virus in a computer network as described in claim 8, wherein the firedoor is connected to an output port of the computer device.

10. The firedoor system for the containment of a virus in a computer network as described in claim 8, wherein the firedoor is connected to a computer network bus.

11. The firedoor system for the containment of a virus in a computer network as described in claim 8, wherein the firedoor is connected to a computer network channel.

12. The firedoor system for the containment of a virus in a computer network as described in claim 8, wherein the firedoor is provided in series with a second firedoor so that different verification criteria from each firedoor are applied serially.
